(19) United States
(12) Patent Application Publication
(10) Pub. No.: US 2014/0188761 A1
(43) Pub. Date: Jul. 3, 2014

(54) SOCIAL NETWORK-BASED INVESTMENT GUIDANCE

(71) Applicant: Nth-Degree Analytics II, Inc., Bozeman, MT (US)

(72) Inventors: Greg D. Adams, Bozeman, MT (US); Timothy W. Amato, Bozeman, MT (US); Kumar R. Dandapani, Bozeman, MT (US)

(73) Assignee: Nth-Degree Analytics II, Inc., Bozeman, MT (US)

(21) Appl. No.: 14/140,992

(22) Filed: Dec. 26, 2013

Related U.S. Application Data
(60) Provisional application No. 61/747,996, filed on Dec. 31, 2012.

(51) Int. Cl. G06Q 40/06; G06Q 50/00

(52) U.S. Cl. CPC G06Q 40/06; G06Q 50/01
USPC 705/36 R

(57) ABSTRACT

Personal and asset transaction information of a plurality of participating investors of a social network-based investment guidance service can be aggregated. A subset of the aggregated personal information and asset transaction information can be defined based on a set of one or more dimensions relating to either or both of the aggregated asset transaction information and personal information of the plurality of participating investors and investor profile information can be presented to the individual participating investor based on the subset.

### CROSS-REFERENCE TO RELATED APPLICATIONS

The current application claims priority under 35 U.S.C. §119(e) to U.S. provisional application for patent No. 61/747,996, which was filed on Dec. 31, 2012, the disclosure of which is incorporated by reference herein.

### TECHNICAL FIELD

The subject matter described herein relates to use of aggregated investor data to assist investors in making investment decisions.

### BACKGROUND

Investors, for example people and groups of organizations who purchase and sell publicly traded assets (e.g. stocks, bonds, options, currencies, commodities, futures contracts, etc.), generally seek as much information as can be reasonably obtained about those publicly traded assets that they currently own and those publicly traded assets that they are considering purchasing.

### SUMMARY

In one aspect, a method includes aggregating personal information and asset transaction information of a plurality of participating investors of a social network-based investment guidance service, defining a subset of the plurality of participating investors, and presenting investor profile information for the subset of participating investors to an individual participating investor of the plurality of participating investors. The asset transaction information includes information about asset transactions completed by an individual participating investor of the plurality of participating investors. The defining includes applying a set of one or more dimensions to the aggregated personal information and asset transaction information. The investor profile information includes an aggregate investing behavior of the subset of participating investors.

In some variations, one or more of the following features can optionally be included in any feasible combination. Access of the individual participating investor to the aggregated personal information and asset transaction information of the plurality of participating investors can be limited, for example by preventing the individual participating investor from receiving the investor profile information for the subset when at least one of the one or more dimensions corresponds to a type of personal information not provided by the individual participating investor for using in the aggregating. The personal information can include at least one of attitudinal information, socio-demographic information, social network information, financial information, gender information, age information, geographical location information, occupation information, an opinion submitted in response to a questionnaire, a survey response, and political affiliation information representative of or otherwise submitted by the individual participating investor. The personal information can be supplemented with additional data associated with an individual participating investor. The additional data can include at least one of data from a public social network, public records data, and other financial transactions of the individual participating investor. The aggregating can include masking personal identifying information of the individual participating investor among the plurality of participating investors. The presenting can include generating investment advice relating to investments of the individual participating investor based on the aggregate investing behavior. The defining can further include receiving the one or more dimensions from the individual participating investor, and creating the subset based on the received one or more aggregated dimensions.

Implementations of the current subject matter can include, but are not limited to, systems and methods including one or more features described herein as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a social network-based investment guidance service consistent with implementations of the current subject matter;

FIG. 2 shows a chart showing an example snapshot based on an investor profile consistent with implementations of the current subject matter;

FIG. 3 shows a diagram illustrating aspects of a system showing features consistent with implementations of the current subject matter;

FIG. 4 shows a diagram illustrating aspects of another system showing features consistent with implementations of the current subject matter;

FIG. 5 shows a process flow chart illustrating features of a method consistent with implementations of the current subject matter; and

FIG. 6 shows another process flow chart illustrating features of a method consistent with implementations of the current subject matter.

When practical, similar reference numbers denote similar structures, features, or elements.

### DETAILED DESCRIPTION

Implementations of the current subject matter relate generally to providing a pool of participating investors with one or more of investment data, analytical tools, and the like to facilitate improved investment decision making. In some variations, the current subject matter can include methods, systems, apparatuses, articles of manufacture, techniques, and the like for collecting and aggregating financial trading and investment information and associated personal information provided by participating investors whose investment activities generate the financial trading and investment information. One or more subsets of the collected and aggregated financial trading and investment information and associated personal information can be made available to participating investors through a series of algorithms that use behavioral, attitudinal, socio-demographic, social network, and financial information that can be directly obtained, indirectly measured, or both from participants in the network. Optionally, a determination can be made to allow or disallow a particular participating investor access to a certain level or grouping of financial trading and investment information and associated demographic data based on an amount of information shared by that particular participating investor.

Through the use of portfolio allocation algorithms consistent with the descriptions herein, a participating investor (e.g. a user) is enabled to perform an asset allocation that modifies a given portfolio to achieve an investment portfolio of a desired profile through manual or automated steps. Alternatively or in addition, aggregated portfolio data from defined investor profiles can be packaged into structured products that are offered by investment management companies.

Implementations of the current subject matter include one or more features that enable a participating investor to safely and anonymously share personal information via a social network-based investment guidance service. The shared personal information can include information about asset transactions (e.g. purchasing and selling of publicly traded assets) as well as other attitudinal information, socio-demographic information, social network information, financial information, etc. Personal information provided by participating investors can optionally be supplemented with data from existing public social networks, public records, a participating investor's financial transactions, or the like. Data shared in this manner by one or more pools of investors can be collected, combined, aggregated, etc. to build large data sets (e.g. a trove or troves of “Big Data”) that can be leveraged by participating investors for use in creating and implementing their own investment strategies. For the purposes of this disclosure, a participating investor is a participant in a social network-based investment guidance service as defined further below.

A series of algorithms or other metrics can be employed to track and aggregate the behavior of the participating investors of the social network-based investment guidance service. Participating investors can be allowed to create subsets of data for aggregated analyses, for example by applying Boolean logic to define and segment dimensions of the data. In an example, a data subset can be defined as (females) AND (account values of $100,000) AND ((owning 100 or more shares of AAPL stock) OR (owning 100 or more shares of GOOG stock)), which would include data for participating investors who are female, have account values in excess of $100,000, and who own 100 shares of at least one of AAPL stock and GOOG stock. One or more algorithms can identify dimensions on which the data can be used to identify commonality or diversity of subsets in meaningful ways. For example, a participating investor can build one or more subsets of data that are most or least like them on single dimensions or combinations of dimensions.

Information derived from investor profiles, which can be defined by participating investors as discussed below, can be delivered to the participating investors through a variety of approaches, including but not necessarily limited to reports, charts, other electronic presentation mechanisms, and the like. Information can be presented in a manner that juxtaposes information about portfolios, trading patterns, and other pertinent data of participating investors against different aggregated dimensions relating to other personal information shared by the participating investors. In some implementations of the current subject matter, portfolio optimization algorithms can be offered to present to a participating investor one or more recommended adjustments to the participating investor's portfolio based on investor profiles selected by the participating investor. The selected investor profiles can be defined specifically by the participating investor or chosen by the participating investor from a group of defined investor profiles defined by other participating investors, as part of a default set of investor profiles, etc.

Consistent with implementations of the current subject matter, a participating investor can make his or her asset transaction data, portfolio data, and one or more aspects of his or her personal information available for inclusion in aggregate analyses or other investment-related analytics conducted by other participating investor in a social network-based investment guidance service. The participating investor can choose, for example via a user interface displayed on a computing device communicating with one or more servers over a network connection, which one or more aspects of his or her personal information is made available for inclusion. A participating investor is provided access to the personal and/or demographic data of other participating investors that those participating investors have made available for inclusion in the aggregate analyses. Consistent with some implementations of the current subject matter, only those types of personal information that a participating investor makes available for inclusion are in turn available for use by that participating investor to perform aggregate analyses or other investment-related analytics. Types of personal information can include, but are not limited to, a participating investor's gender, age, geographical location, occupation or class of occupation (e.g. office worker, teacher, manufacturing, etc.), opinions or results submitted in response to questionnaires or surveys or the like, political affiliation, etc. In other implementations of the current subject matter, an investor is not limited in the types of information that he or she can access for performing aggregate analyses or other investment-related analytics.

One example of aggregate analyses or other investment-related analytics that a participating investor can employ based on the types of personal information provided by other participating investors to which he or she has access is the ability to create “investor profiles.” An investor profile as used herein refers to a feature or a set of two or more features defining a group. In an example in which a participating investor's access to personal information submitted by other participating investors is impacted by the types of personal information he or she makes available for inclusion in aggregate analyses performed by other participating investors, the participating investor can thereby be encouraged to share more of his or her personal information, which can cause the overall quality of the aggregated data to improve. Participating investors can make use of the aggregate analyses to create investor profiles and track stock trades, portfolio characteristics, or other investment patterns of investors matching those investor profiles. Additionally, investor profiles created by other participating investors can be shared among other participating investors. A predefined set of default investor profiles can also be made available for use by participating investors.

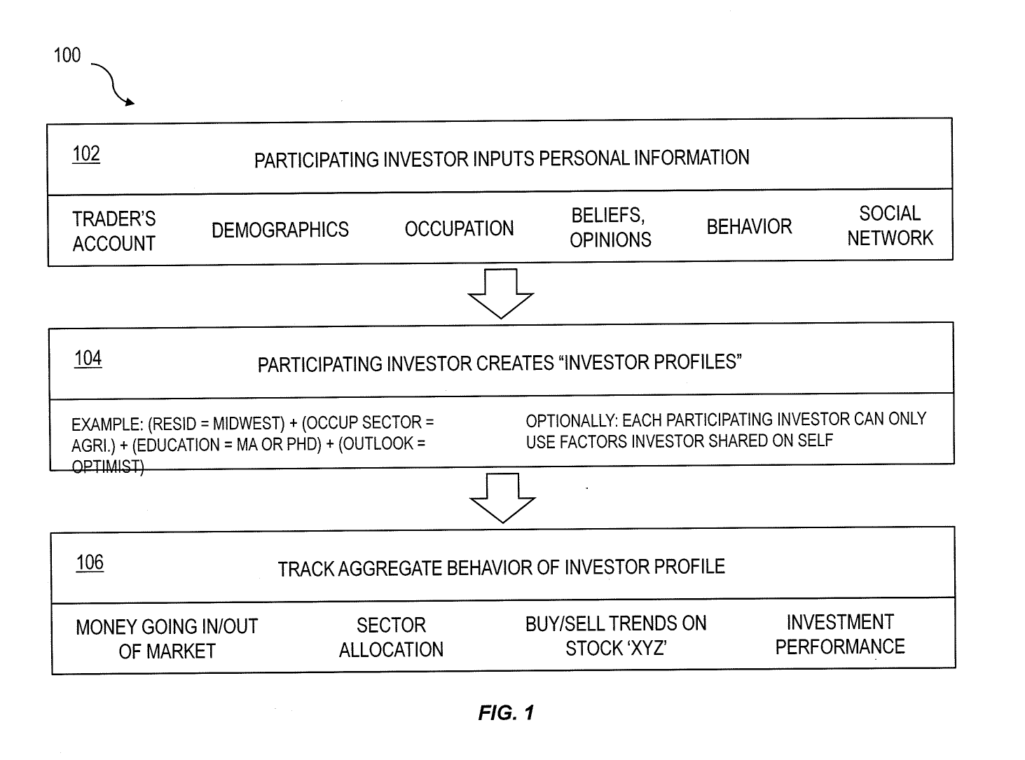

FIG. 1 shows a diagram 100 illustrating features of a process by which a participating investor can make use of a social network-based investment guidance service consistent with implementations of the current subject matter. At 102, the participating investor inputs his or her personal information. Personal information can include, but is not limited to, the investor's account information (e.g. one or more of a current balance of an account, positions in securities held in the account, tradable assets held by the investor in the account, trades made by the investor using the account, etc.) for one or more accounts owned or controlled by the participating investor (e.g. online trading accounts, brokerage accounts, retirement accounts, direct investment accounts, other securities or assets held outside of a formal account, etc.); demographic information about the participating investor; the participating investor's occupation, values, beliefs, opinions, behavior, socio-economic status, education, life experiences, approaches to investing, personal level of risk aversion, religious affiliations, political affiliations, social affiliations, or the like; social network information of the participating investor (e.g. information about the networks to which the participating investor belongs, information about contacts of the participating investor within the social network or retained offline, or the like); etc.

Consistent with implementations of the current subject matter, a participating investor can choose which types of personal information he or she will allow to be shared to the social network-based investment guidance service. The personal information that is shared by the individual investor is added to personal data shared by other participating investors to form a pool of data that can be queried or otherwise analyzed, for example in making investment decisions.

An optional feature can limit a participating investor from automatically gaining access to the entire pool of data in that a participating investor can be allowed access to types of data in the pool of data that correspond to the types of personal data made available by the participating investor to the social network-based investment service. As an illustrative example, the participating investor may choose to not reveal information about his or her age. However, as a consequence of not revealing this type of personal information, the participating investor would not be able to use age information as a criterion in defining an investor profile. In this manner, participating investors can control what personal information to share about themselves, but each participating investor only receives in return information commensurate with what he or she has allowed to be shared. This feature can create an incentive for participating investors to reveal more information, thereby generating a larger pool of aggregated data, which can drive improved value of investor profiles created by participating investors to drive their individual investment decisions. An individual participating investor's personal information is not directly revealed due to aggregation, so anonymity and privacy of participating investors can be maintained. In general, account information (e.g. balance, positions, trades, etc.) must be revealed by a participating investor to participate in the social network-based investment guide service.

To protect the privacy of participating investors, personal information of a participating investor is not revealed to other participating investors in the social network-based investment service. Rather, only aggregate information from multiple participating investors is presented to any one participating investor. A participating investor can withdraw, conceal, or otherwise restrict access to personal information that has been previously shared with the social network-based investment service. However, in some implementations of the current subject matter, the act of withdrawing the personal information from accessibility by other participating investors in the social network-based investment service can be delayed for a period of time. The period of time can be set as a parameter by the operator of the social network-based investment service according to a choice of an operator or by a policy established by the social network-based investment service. The delay in removal of a participating investor's personal information from access by other participating investors of the social network-based investment service can be put in place to deter a participating investor from previously providing his or her personal information with the intent of merely gaining access to the a larger amount of aggregated data in the pool of data without making a bona fide contribution of his or her own personal information that can be useful to other participating investors in the social network-based investment service.

In some implementations of the current subject matter, the trade information, account information, etc. of a participating investor can be automatically provided from a brokerage or trading account owned or otherwise controlled by that participating investor. For example, a brokerage or trading firm that handles and maintains accounts for a group of investor customers can implement the social network-based investment guidance service in-house as a benefit for its customers. In such an example, the pool of participating investors from whom personal information is collected can be limited to the group of investor customers. Optionally, those investor customers could individually choose to participate or not participate in the social network-based investment guidance service offered in-house by the brokerage or trading firm.

In another example, a third party service can offer the social network-based investment guidance service as a subscription service that one or more brokerage or trading firms can provide to their investor customers. In yet another example, a third party service can offer the social network-based investment guidance service directly to participating investors as a standalone service that is independent of the brokerage or trading firm that handles actual transactions, etc. for any given participating investor. In the example of a brokerage or trading firm offering the social network-based investment guidance service to its own investor customers, the brokerage or trading firm would already have access to the transactional data of its investor customers and might therefore only require consent from a specific participating investor to use the personal information supplied by that participating investor as part of an aggregated pool of data.

In the case of a third party service offering the social network-based investment guidance service, it can be necessary to obtain release consent from a participating investor to allow sharing (e.g. electronic transmission from the brokerage or trading firm to the social network-based investment guidance service) of the trade and asset portfolio information of the participating investor from the brokerage or trading firm to the social network-based investment guidance service. In other implementations of the current subject matter, a participating investor can manually enter or transmit his or her trade and asset portfolio information to the social network-based investment guidance service. In a further implementation of the current subject matter, a participating investor can authorize the social network-based investment guidance service to access (e.g. via a login and password or other electronic portal approach) an online brokerage or trading account owned or controlled by the participating investor for the purposes of automatically accessing trade and asset portfolio information of the participating investor.

Referring again to FIG. 1, at 104, a participating investor can create one or more investor profiles, each of which can specify a feature (e.g. a criterion, a parameter, etc.) or set of features define a grouping of data from the pool of data of other participating investors. As illustrative examples, an investor profile can specify a single feature, such as one relating to religious beliefs (e.g. “Jewish” or “Agnostic” or “Roman Catholic” or the like), or multiple features, such as features relating to gender, location of residence (e.g. a region like Northern California, a county, a state, a city, a country, etc.), and level of education attained (e.g. specific degrees held, total number of years of education, or the like). As noted above, a participating investor can optionally be limited to building profiles using only the types of information or “features” that he or she has shared about himself or herself with the social network-based investment guidance service. In some implementations of the current subject matter, an investor profile can be disabled in a data set if the features specified by a participating investor in a request for an investor profile would contain too few (e.g. less than a pre-determined threshold number of) other participating investors. Such an approach can be useful in protecting the anonymity of any specific participating investor.

Again in reference to FIG. 1, at 106 an aggregate investing behavior of participating investors captured within an investor profile can be tracked. The resulting aggregated tracking data can be provided to the participating investor who defined the investor profile, and optionally also to other participating investors, for example if the social network-based investment guidance service allows sharing of defined investor profiles among participating investors. In some implementations of the current subject matter, tracking can be facilitated through the use of profile snapshots, which can include one or more criteria displayed graphically. For example, an aggregated asset distribution (e.g. what fraction of the assets of the aggregated participating investors contained within the investor profile (referred to here as “the group”) are held in cash, bonds, stocks, mutual funds, etc.) can be generated and graphically displayed to a participating investor based on an investor profile define or otherwise used by the participating investor. Other snapshots can include a distribution of trades or assets across economic sectors (e.g. transport, technology, energy, etc.) for the group, a coefficient of wealth distribution for the group, statistics (e.g. mean, median, standard deviation, percentile ranks, etc.) of wealth among the group, statistics regarding specific stocks or other assets held by the group, a percent cash equivalent held by the group, changes over a specified time period (e.g. hour, day, week, month, year, etc.) of other metrics, an amount of cash or other value contributed to or withdrawn from investment activities by the group over a specified time period, a relative or absolute change in total value of the aggregated portfolio of the group over a specified time, an extent to which the composition of the portfolio changes over a specified time, statistics on a number of trades per member of the group per a specific time period, a ranking or “leaderboard” (e.g. a “top 10,” etc.) of holdings within the group (e.g. by number of participating investors holding a specific asset, total amount of value held in a specific asset by the group, etc.), rankings or leaderboards of assets sold or bought within a specified time period, rankings or leaderboards of net gains or losses within a specified time period, mutual fund-typed scores (e.g. on risk, volatility, etc.) for investment activities of the group, etc.

Other approaches to tracking aggregate behavior of the group defined by an investor profile can include activities of the group occurring within a specified time period with respect to a specific asset (e.g. a stock, fund, bond, etc.). Such activities can include, without limitation, an indication of a number of participating investors in the group holding shares (or other units) of the stock or other asset, statistics regarding number of shares (or other units) per holder of a stock or other asset a within the group, a total market value of shares or other units of the stock or other asset for the group, statistics on market value of the stock or other asset per holder within the group, a number (e.g. total, per participating investor in the group, etc.) of shares or other units or a total value of the stock or other asset bought or sold by the group, a net number of shares or other units of the stock or other asset or net value of the stock or other asset traded (e.g. total shares bought minus total shares sold) by members of the group, a total number of shares or other units of the stock or other asset held by members of the group, etc. Such information can optionally be used for comparisons of assets. As an illustrative example, a determination can be made that twenty percent of stock in Apple Computer, Inc. (AAPL) is held by investors over age 65, while 70% of stock in Exxon Mobile Corporation (XOM) is held by investors over age 65.

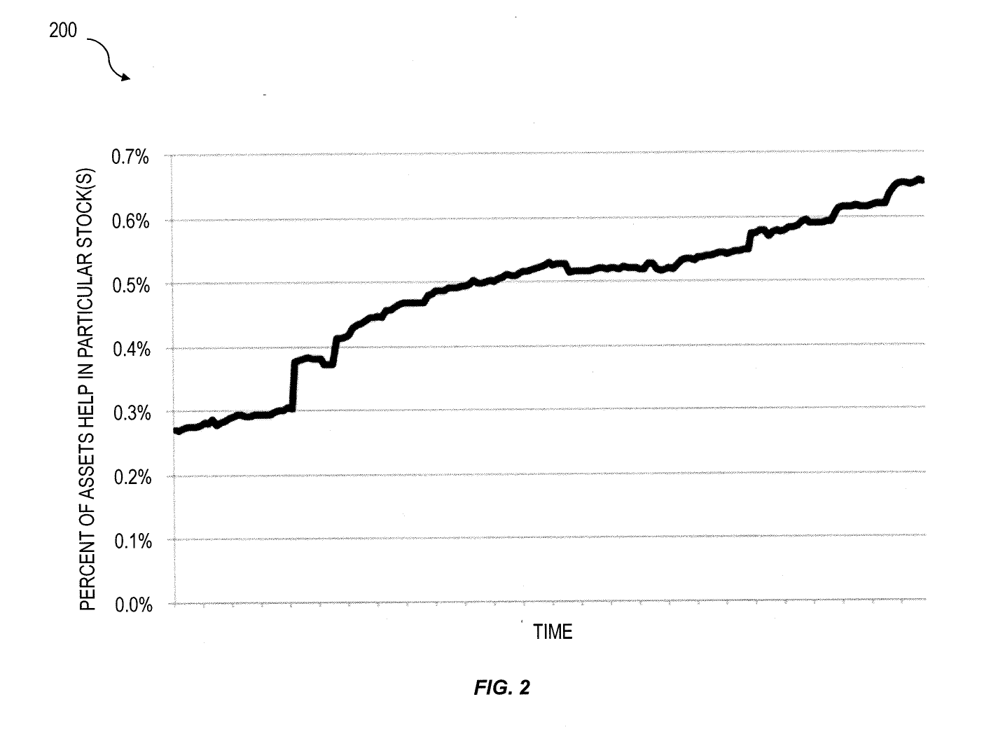

FIG. 2 shows an example of a chart 200 that can be generated as a snapshot on an investor profile. In this example, the features of the investor profile include males living in New Jersey with ages between 24 and 39. The chart 200 shows a percent of the total assets of the group defined by the profile that are invested in a particular asset (e.g. AAPL, XOM, etc.).

In additional implementations of the current subject matter, one or more exchange traded funds (ETFs) or other investment vehicles can be built using investor profiles as discussed herein. In this example, an investor profile can be defined, and an automated trading system can reproduce an asset distribution specified by the investor profile to thereby create an ETF that can be traded on public exchanges. Such an ETF can mirror an aggregate portfolio allocation of an investor profile and can reallocate stock (or other asset) holdings to reflect the proportion of the holdings in each asset (e.g. on stock exchanges) by the group of participating investors captured in the investor profile. In another example, calls, puts, shorts, and other derivative-based trading schemes can be constructed in an automated manner based on such investor profile-based ETFs.

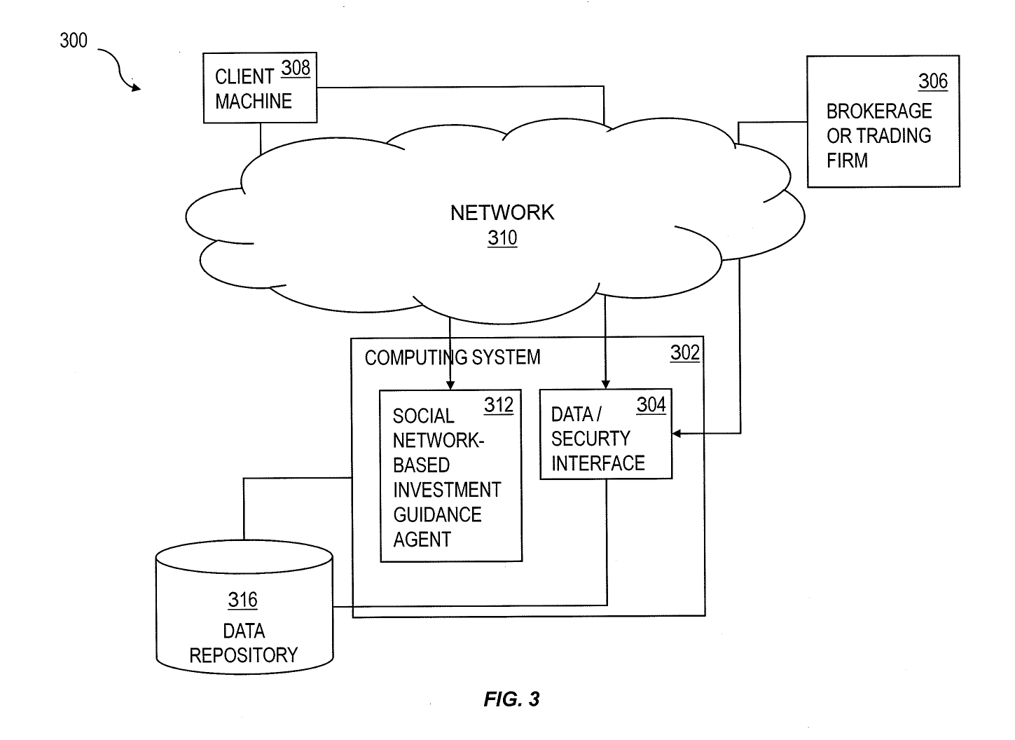

FIG. 3 shows a diagram of a system architecture 300 consistent with implementations of the current subject matter. A computing system 302 can include one or more data or security interface modules or agents 304 that can interface with data systems at one or more brokerage or trading firms 306 and that can directly receive personal information and/or trading information provided by a participating investor using a client machine 308. Client machines 308 and brokerage or trading firms 306 can access the computing system 302, either via a direct connection, a local terminal, or over a network 310 (e.g. a local area network, a wide area network, a wireless network, the Internet, or the like). A social network-based investment guidance agent 312 can be hosted on the computing system 302 or alternatively, on an external system accessible over a network connection. The social network-based investment guidance agent 312 can optionally include one or more discrete software and/or hardware modules that perform operations such as those described herein. The data/security interface 304 as well as the social network-based investment guidance agent 312 can access one or more data repositories 316 that can store data relating to investor asset transactions, investor portfolios, and investor personal and/or demographic data.

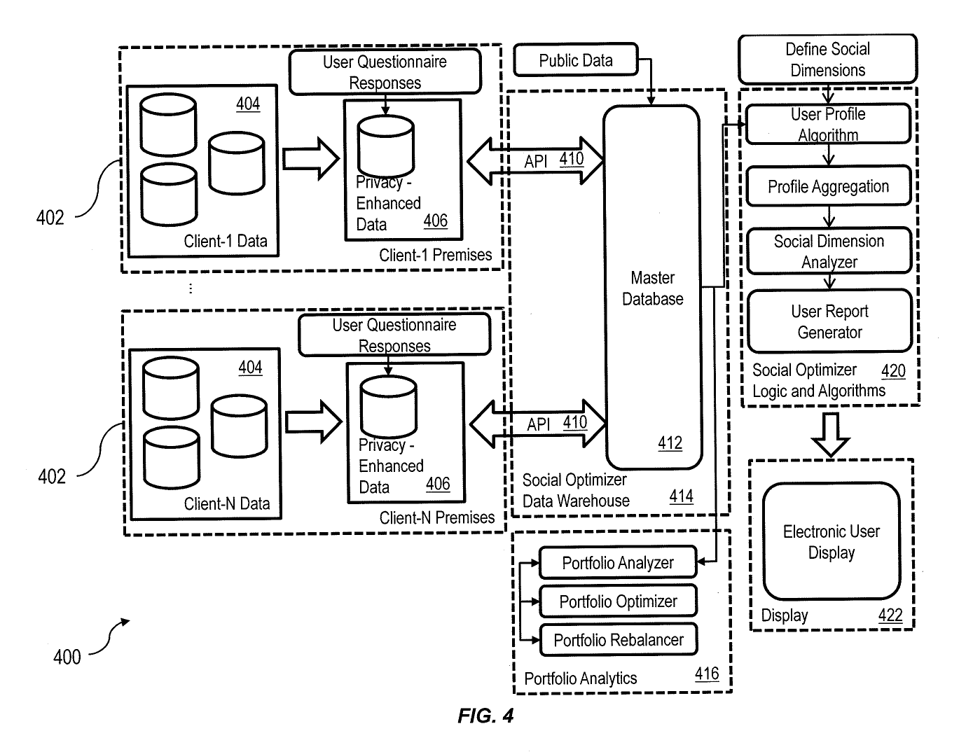

FIG. 4 shows a diagram of another system architecture 400 consistent with implementations of the current subject matter. One or more financial institutions 402 (e.g. brokerages, trading houses, etc.) offering features of a social network-based investment guidance service to their clients (e.g. participating investors) can store asset transaction data 404 (e.g. trade information, asset balances, portfolio data, etc.) of their client investors. The asset transaction data 404 can be stored locally at computing devices (e.g. servers, computers, etc.) of each of the one or more financial institutions 402 or accessed over a network. One or more programs or other comparable software functionality can be installed to run on the computing devices of the one or more financial institutions 402. These one or more programs can add privacy enhancements to the asset transaction data 404, such as for example removal of identifying information, etc., to prepare privacy-enhanced data 406 suitable for sharing with the social network-based investment guidance service. The privacy-enhanced data 406 can also be augmented with responses submitted by participating investors in response to one or more questionnaires, which can allow a participating investor to provide additional information about other personal information, such as for example that discussed above. The personal information can also be privacy enhanced for sharing with the social network-based investment guidance service.

Via one or more application programming interfaces (APIs) 410, the privacy-enhanced data 406 are added to a master database 412, which can be a local database, a distributed database (e.g. accessible over a network or stored in “the cloud”), etc. that aggregates the privacy-enhanced data 406 received from the one or more financial institutions 402. The master database 412 can be part of a social optimizer data warehouse 414, and can be accessed by a portfolio analytics module or program 416 as well as a set of social optimizer logic and algorithms 420. The portfolio analytics module or program 416 can optionally include one or more additional features, such as for example a portfolio analyzer, a portfolio optimizer, a portfolio rebalance, etc., which a participating investor can user to make investment decisions based on at least a subset of the data stored in the master database 412. The set of social optimizer logic and algorithms 420 can include one or more additional features, such as for example a user profile algorithm, profile aggregation capabilities, social dimension analyzers, user report generators, etc., which can support the provision of snapshots, etc. to participating investors, optionally based on user input such as definitions of one or more social dimensions. Results based on the set of social optimizer logic and algorithms 420 can be displayed to participating investors, for example via an electronic display 422, which can be part of a computing device (e.g. a laptop or desktop computer), a portable networked device (e.g. a smart phone, a tablet, etc.), or the like used by a participating investor.

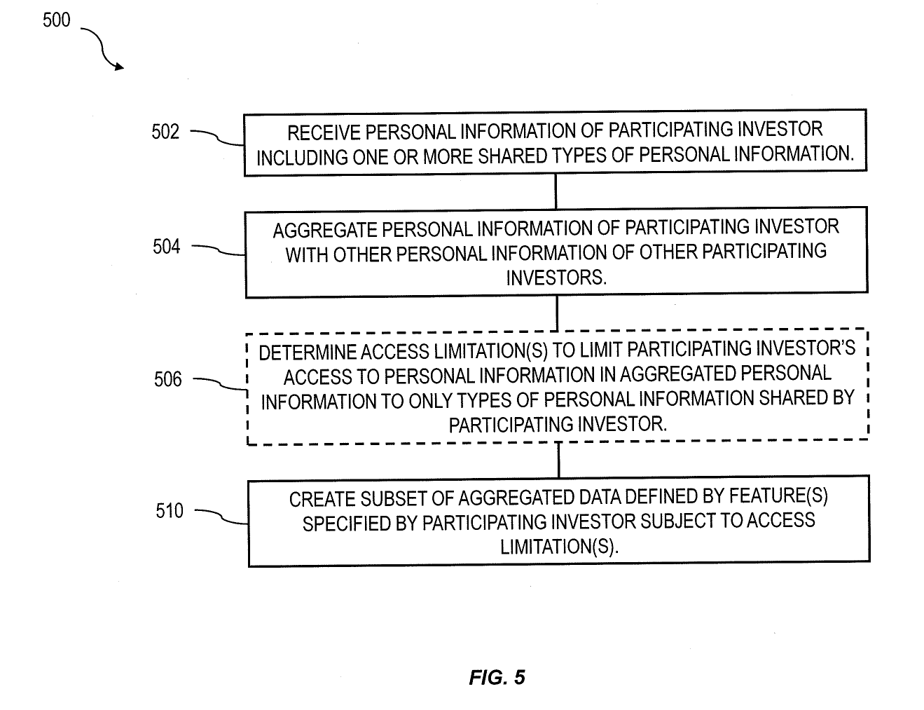

FIG. 5 shows a process flow chart 500 illustrating features of a method consistent with one or more implementations of the current subject matter. At 502, personal information of a participating investor is received at a system implementing a social network-based investment guidance service. The personal information includes one or more shared types of personal information. At 504 the received personal information is aggregated with personal information of a collection of other participating investors such that anonymity of the participating investor is protected. Based on the types of personal information shared by the participating investor, one or more access limitations can optionally be determined at 506 to limit the participating investor's access to personal information in the aggregated personal information to only those types of personal information shared by the participating investor. In response to a set of one or more features specified by the participating investor, a subset of the aggregated data defined by the set of one or more features is created at 510 subject to the limitations.

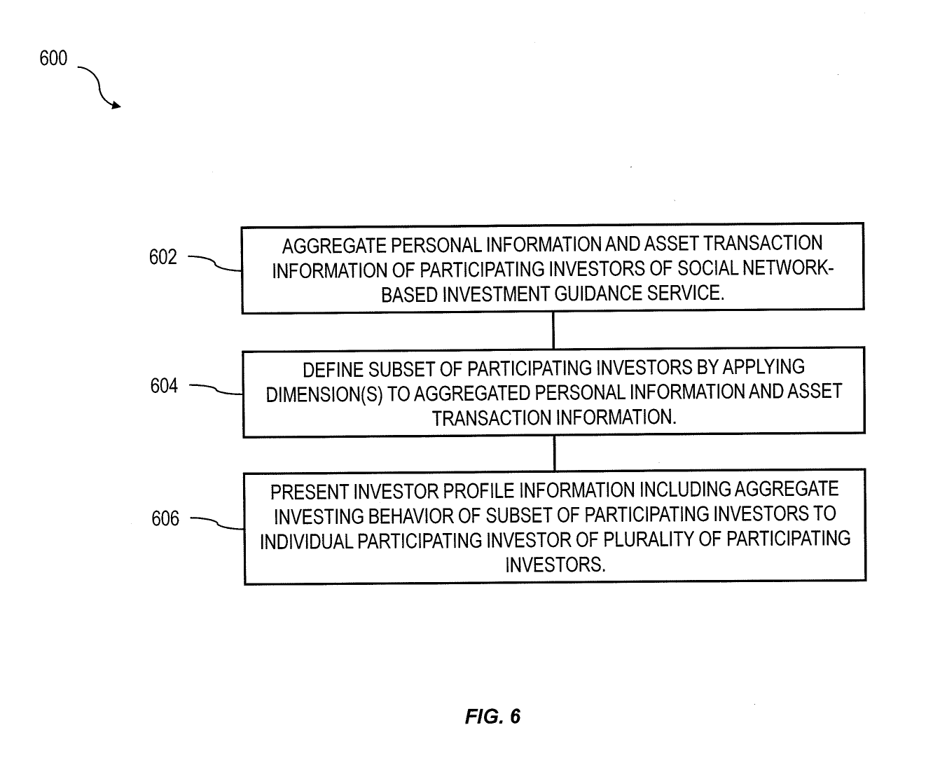

FIG. 6 shows a process flow chart 600 illustrating features of a method consistent with one or more implementations of the current subject matter. At 602, personal information and asset transaction information of a plurality of participating investors of a social network-based investment guidance service are aggregated. The asset transaction information includes information about asset transactions completed by an individual participating investor of the plurality of participating investors, and the personal information optionally includes one or more of attitudinal information, socio-demographic information, social network information, financial information, gender information, age information, geographical location information, occupation information, an opinion submitted in response to a questionnaire, a survey response, and political affiliation information representative of or otherwise submitted by one or more individual participating investors of the plurality of participating investors. The personal information can optionally be supplemented with additional data associated with an individual participating investor. The additional data can include at least one of data from a public social network, public records data, and other financial transactions of an individual participating investor.

At 604, a subset of the plurality of participating investors is defined by applying a set of one or more dimensions to the aggregated personal information and asset transaction information. The defining can optionally include receiving the one or more dimensions from the individual participating investor and creating the subset based on the received one or more aggregated dimensions.

At 606, investor profile information for the subset of participating investors can be presented to an individual participating investor of the plurality of participating investors. The investor profile information can include an aggregate investing behavior of the subset of participating investors. The presenting can include generation of one or more reports, charts, or other textual or graphical representations of the aggregate investing behavior. Alternatively or in addition the presenting can include use of the aggregate investing behavior to generate investment advice relating to investments of the individual participating investor.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable storage medium storing instructions that, when executed by at least one programmable processor, cause the at least one programmable processor to perform operations comprising:
aggregating personal information and asset transaction information of a plurality of participating investors of a social network-based investment guidance service, the asset transaction information comprising information about asset transactions completed by an individual participating investor of the plurality of participating investors;
defining a subset of the plurality of participating investors, the defining comprising applying a set of one or more dimensions to the aggregated personal information and asset transaction information;
presenting investor profile information for the subset of participating investors to an individual participating investor of the plurality of participating investors, the investor profile information comprising an aggregate investing behavior of the subset of participating investors.

2. A computer program product as in claim 1, wherein the operations further comprise limiting access of the individual participating investor to the aggregated personal information and asset transaction information of the plurality of participating investors, the limiting comprising preventing the individual participating investor from receiving the investor profile information for the subset when at least one of the one or more dimensions corresponds to a type of personal information not provided by the individual participating investor for using in the aggregating.

3. A computer program product as in claim 1, wherein the personal information comprises at least one of attitudinal information, socio-demographic information, social network information, financial information, gender information, age information, geographical location information, occupation information, an opinion submitted in response to a questionnaire, a survey response, and political affiliation information representative of or otherwise submitted by the individual participating investor.

4. A computer program product as in claim 1, wherein the operations further comprise supplementing the personal information with additional data associated with an individual participating investor, the additional data comprising at least one of data from a public social network, public records data, and other financial transactions of the individual participating investor.

5. A computer program product as in claim 1, wherein the aggregating comprises masking personal identifying information of the individual participating investor among the plurality of participating investors.

6. A computer program product as in claim 1, wherein the presenting comprises generating investment advice relating to investments of the individual participating investor based on the aggregate investing behavior.

7. A computer program product as in claim 1, wherein the defining further comprises receiving the one or more dimensions from the individual participating investor, and creating the subset based on the received one or more aggregated dimensions.

8. A system comprising:
computer hardware configured to perform operations comprising:
aggregating personal information and asset transaction information of a plurality of participating investors of a social network-based investment guidance service, the asset transaction information comprising information about asset transactions completed by an individual participating investor of the plurality of participating investors;
defining a subset of the plurality of participating investors, the defining comprising applying a set of one or more dimensions to the aggregated personal information and asset transaction information;
presenting investor profile information for the subset of participating investors to an individual participating investor of the plurality of participating investors, the investor profile information comprising an aggregate investing behavior of the subset of participating investors.

9. A system as in claim 8, wherein the operations further comprise limiting access of the individual participating investor to the aggregated personal information and asset transaction information of the plurality of participating investors, the limiting comprising preventing the individual participating investor from receiving the investor profile information for the subset when at least one of the one or more dimensions corresponds to a type of personal information not provided by the individual participating investor for using in the aggregating.

10. A system as in claim 8, wherein the personal information comprises at least one of attitudinal information, socio-demographic information, social network information, financial information, gender information, age information, geographical location information, occupation information, an opinion submitted in response to a questionnaire, a survey response, and political affiliation information representative of or otherwise submitted by the individual participating investor.

11. A system as in claim 8, wherein the operations further comprise supplementing the personal information with additional data associated with an individual participating investor, the additional data comprising at least one of data from a public social network, public records data, and other financial transactions of the individual participating investor.

12. A system as in claim 8, wherein the aggregating comprises masking personal identifying information of the individual participating investor among the plurality of participating investors.

13. A system as in claim 8, wherein the presenting comprises generating investment advice relating to investments of the individual participating investor based on the aggregate investing behavior.

14. A system as in claim 8, wherein the defining further comprises receiving the one or more dimensions from the individual participating investor, and creating the subset based on the received one or more aggregated dimensions.

15. A computer-implemented method comprising:
aggregating personal information and asset transaction information of a plurality of participating investors of a social network-based investment guidance service, the asset transaction information comprising information about asset transactions completed by an individual participating investor of the plurality of participating investors;
defining a subset of the plurality of participating investors, the defining comprising applying a set of one or more dimensions to the aggregated personal information and asset transaction information;
presenting investor profile information for the subset of participating investors to an individual participating investor of the plurality of participating investors, the investor profile information comprising an aggregate investing behavior of the subset of participating investors.

16. A computer-implemented method as in claim 15, further comprising limiting access of the individual participating investor to the aggregated personal information and asset transaction information of the plurality of participating investors, the limiting comprising preventing the individual participating investor from receiving the investor profile information for the subset when at least one of the one or more dimensions corresponds to a type of personal information not provided by the individual participating investor for using in the aggregating.

17. A computer-implemented method as in claim 15, wherein the personal information comprises at least one of attitudinal information, socio-demographic information, social network information, financial information, gender information, age information, geographical location information, occupation information, an opinion submitted in response to a questionnaire, a survey response, and political affiliation information representative of or otherwise submitted by the individual participating investor.

18. A computer-implemented method as in claim 15, wherein the operations further comprise supplementing the personal information with additional data associated with an individual participating investor, the additional data comprising at least one of data from a public social network, public records data, and other financial transactions of the individual participating investor.

19. A computer-implemented method as in claim 15, wherein the aggregating comprises masking personal identifying information of the individual participating investor among the plurality of participating investors.

20. A computer-implemented method as in claim 15, wherein the presenting comprises generating investment advice relating to investments of the individual participating investor based on the aggregate investing behavior.
